(19) United States
(12) Patent Application Publication
(10) Pub. No.: US 2019/0143406 A1
(43) Pub. Date: May 16, 2019

(54) ADDITIVE MANUFACTURING APPARATUS AND METHOD FOR LARGE COMPONENTS

(71) Applicant: General Electric Company, Schenectady, NY (US)

(72) Inventors: William Thomas Carter, Galway, NY (US); David Charles Bogdan, JR., Charlton, NY (US); Jason Harris Karp, NIskayuna, NY (US); Justin John Gambone, JR., Watervliet, NY (US); Victor Petrovich Ostroverkhov, Ballston Lake, NY (US); Marshall Gordon Jones, Scotia, NY (US); Kevin George Harding, Niskayuna, NY (US); Younkoo Jeong, Clifton Park, NY (US); Michael Robert Tucker, Niskayuna, NY (US); Subhrajit Roychowdhury, Niskayuna, NY (US)

(21) Appl. No.: 15/810,308

(22) Filed: Nov. 13, 2017

(51) Int. Cl. B22F 3/00; B22F 3/105; B29C 64/153; B29C 64/245; B29C 64/386

(52) U.S. Cl. CPC B22F 3/003; B22F 3/1055; B22F 3/005; B29C 64/268; B29C 64/245; B29C 64/386; B29C 64/153

(57) ABSTRACT

An additive manufacturing apparatus includes first and second spaced apart side walls defining a build chamber therebetween. The first and second spaced apart side walls are configured to rotate through an angle θ, about a z-axis along a pre-defined path. A build platform is defined within the first and second spaced apart side walls and is configured to rotate through an angle θ about the z-axis and vertically moveable along the z-axis. The apparatus further includes one or more build units mounted for movement along the pre-defined path. An additive manufacturing method is additionally disclosed.

### BACKGROUND

This invention relates generally to an additive manufacturing apparatus and more particularly to an apparatus for large components.

“Additive manufacturing” is a term used herein to describe a process which involves layer-by-layer construction or additive fabrication (as opposed to material removal as with conventional machining processes). Such processes may also be referred to as “rapid manufacturing processes”. Additive manufacturing processes include, but are not limited to: Direct Metal Laser Melting (DMLM), Laser Net Shape Manufacturing (LNSM), electron beam sintering, Selective Laser Sintering (SLS), 3D printing, such as by inkjets and laserjets, Sterolithography (SLA), Electron Beam Melting (EBM), Laser Engineered Net Shaping (LENS), and Direct Metal Deposition (DMD).

Currently, powder bed technologies have demonstrated the best resolution capabilities of prior art metal additive manufacturing technologies. However, since the build needs to take place in the powder bed, conventional machines use a large amount of powder, for example a powder load can be over 130 kg (300 lbs.). This is costly when considering a factory environment using many machines. The powder that is not directly melted into the part but stored in the neighboring powder bed is problematic because it adds weight to the elevator systems, complicates seals and chamber pressure problems, is detrimental to part retrieval at the end of the part build, and becomes unmanageable in large bed systems currently being considered for large components. Dispensed, infused powder may also become contaminated by byproducts of the machine and process, which precludes its direct reuse.

In addition, other issues with conventional machines used in powder bed technologies include, but are not limited to, the requirement for serial operation of a recoater and the laser system, requiring one to be off while the other operates, reducing productivity and the use of a large gas cover that must be utilized to cover the entire large powder bed, leading to design problems associated with gas dynamics.

Accordingly, there remains a need for an additive manufacturing apparatus and method that can produce large parts with improved productivity.

### BRIEF DESCRIPTION

Various embodiments of the disclosure include an additive manufacturing apparatus and method for large components. In accordance with one exemplary embodiment, disclosed is an additive manufacturing apparatus. The apparatus including first and second spaced apart side walls defining a build chamber therebetween, a build platform defined within the first and second spaced apart side walls and one or more build units mounted for movement along the pre-defined path. The first and second spaced apart side walls are configured to rotate through an angle θ, about a z-axis along a pre-defined path. The build platform is defined within the first and second spaced apart side walls and configured to rotate through an angle θ about the z-axis and vertically moveable along the z-axis.

In accordance with another exemplary embodiment, disclosed is an additive manufacturing apparatus including an outer powder containment wall defining a build chamber therein, a build platform defined within the build chamber, and one or more build units mounted for movement along the pre-defined path. The outer powder containment wall is configured to rotate through an angle θ, about a z-axis along a pre-defined path. The build platform is configured to rotate through an angle θ about the z-axis and vertically moveable along the z-axis. The one or more build units collectively include a powder dispenser positioned above the build chamber, an applicator configured to level the powder dispensed into the build chamber and a directed energy source configured to fuse the leveled powder. The powder dispenser, the applicator and the directed energy source are configured for continuous operation.

In accordance with yet another exemplary embodiment, disclosed is an additive manufacturing method, including positioning one or more build units over a build chamber defined by first and second spaced-apart side walls. The first and second spaced apart side walls are configured to rotate through an angle θ, about a z-axis along a pre-defined path. The method further including moving the one or more build units relative to the build chamber along the pre-defined path, using the one or more build units to continuously deposit powder onto a build platform contained in the build chamber and form a layer increment of powder thereon, using the one or more build units to direct a beam from a directed energy source to continuously fuse the powder, vertically moving at least one of the build platform, first and second spaced-apart walls, and one or more build units by the layer increment in a continuous manner and continuously repeating in a cycle the steps of depositing, directing, and moving to build up a part in a layer-by-layer fashion until the part is complete. The build platform is configured to rotate through an angle θ about the z-axis and vertically moveable along the z-axis.

Other objects and advantages of the present disclosure will become apparent upon reading the following detailed description and the appended claims with reference to the accompanying drawings. These and other features and improvements of the present application will become apparent to one of ordinary skill in the art upon review of the following detailed description when taken in conjunction with the several drawings and the appended claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a cross-sectional view of an additive manufacturing apparatus constructed in accordance with one or more embodiments shown or described herein;

FIG. 2 is a cross-sectional view of an alternative additive manufacturing apparatus constructed, in accordance with one or more embodiments shown or described herein;

FIG. 3 is a cross-sectional view of an alternative additive manufacturing apparatus constructed, in accordance with one or more embodiments shown or described herein;

FIG. 4 is a cross-sectional view of an alternative additive manufacturing apparatus constructed, in accordance with one or more embodiments shown or described herein; and

FIG. 5 is a flowchart illustrating the steps in an additive manufacturing method, in accordance with one or more embodiments shown or described herein.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

It is noted that the drawings as presented herein are not necessarily to scale. The drawings are intended to depict only typical aspects of the disclosed embodiments, and therefore should not be considered as limiting the scope of the disclosure. In the drawings, like numbering represents like elements between the drawings.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations are combined and interchanged. Such ranges are identified and include all the sub-ranges contained therein unless context or language indicates otherwise.

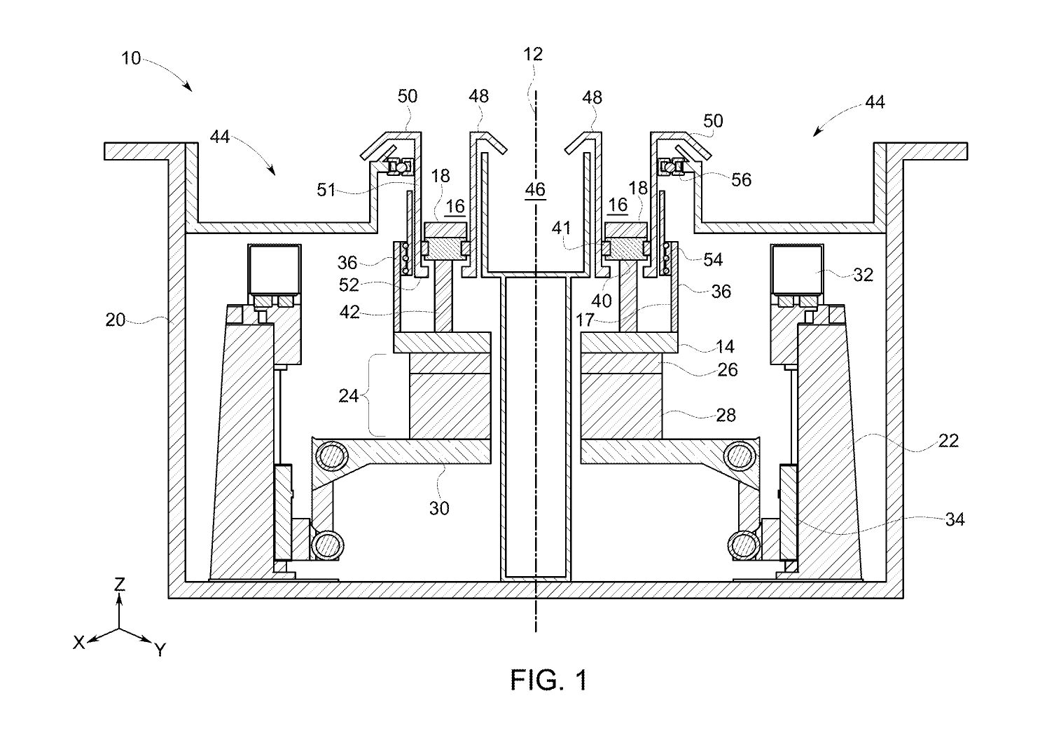

Referring to the drawings wherein identical reference numerals denote the same elements throughout the various views, FIG. 1 illustrates an exemplary additive manufacturing apparatus 10 constructed according to the technology described herein. As illustrated, the apparatus 10 in this particular embodiment is annularly formed about a z-axis 12. The basic components are a turntable 14, a build chamber 16 surrounding a build platform 18, a housing 20, a moveable platform 30 and a support structure 22 disposed in the housing 20. Each of these components will be described in more detail below.

The turntable 14 is a rigid structure configured to move vertically (i.e. parallel to the z-axis 12), as well as rotate continuously about the z-axis 12. As illustrated, the turntable 14 is secured to a rotary stage 24, comprised of a rotating portion 26 and a non-rotating portion 28. The rotating portion 26 supports unconstrained rotation of the turntable 14 by an arbitrary number of revolutions to enable building of multiple layers of the part without changing direction of the rotation. In this particular embodiment, the turntable 14 is secured to the rotating portion 26 of the rotary stage 24. The rotary stage 24 incorporates a direct drive motor, which serves as a rotatory actuator, and is operable to selectively rotating the rotating portion 26 of the rotary stage 24, which translates to continuous rotation of the turntable 14. The rotary stage 24, and more particularly, the non-rotating portion 28, is secured to the moveable platform 30. The moveable platform 30 is a rigid structure configured to move vertically along the z-axis 12 (i.e. parallel to the z-axis 12). In this particular embodiment, the moveable platform 30 does not rotate. The rotary stage 24 contains an actuator that causes the rotating portion 26 to rotate 360 degrees about the non-rotating, or stationary, portion 28, which translates to 360 degree rotation of the turntable 14. A motor 32 is operable to selectively move the moveable platform 30 vertically up or down via a linear actuator 34. The linear actuator 34 is secured to the stationary support structure 22 in a manner that provides for the vertical movement of the moveable platform 30, and as a result vertical movement of the rotary stage 24, and the turntable 14. The linear actuator 34 and rotary actuator 24 are depicted schematically in FIG. 1. Whenever the term “actuator” is used herein, it will be understood that devices such as pneumatic or hydraulic cylinders, ballscrew or linear actuators, and so forth, may be used for this purpose. The motor 32 and rotary stage 24 are depicted schematically in FIG. 1, with the understanding that any device that will produce controlled linear and rotary motion, respectively, may be used for this purpose.

The build chamber 16 is defined by a plurality of spaced apart sidewalls, and more particularly, an inner powder containment wall 48 and an outer powder containment wall 50. A rotating pillar 36 extends perpendicularly upward from the turntable 14. It should be appreciated that the rotating pillar 36 may extend upwardly from the turntable 14 at angles other than ninety degrees. The rotating pillar 36 provides transmission of the rotating force of the rotating portion 26 of the rotary stage 24 to the inner powder containment wall 48 and the outer powder containment wall 50 via a linear bearing 54. The linear bearing 54 is disposed between an outer surface of the build chamber 16, and more particularly an outer surface 51 of the outer powder containment wall 50, and an inner surface 17 of the rotating pillar 36. The inner powder containment wall 48 and the outer powder containment wall 50 define a path in the form of an annular ring about the z-axis 12.

The build platform 18 is a plate-like structure that is vertically slideable in the build chamber 16. The build platform 18 is secured to a base plate 40 and the turntable 14 by a connecting rod, or set of connecting rods, 42. Metal powder is prevented from falling between the baseplate 40 and the inner containment wall 48 and outer containment wall 50 with a sliding seal 41.

As illustrated in FIG. 1, disposed within the housing 20 are an outer powder trap 44 and an inner powder trap 46. The inner powder trap 46 extends vertically along the z-axis 12 to rest on a lower portion of the housing 20. As previously described, the inner powder containment wall 48 and the outer powder containment wall 50 are rotatably disposed about the build platform 18. The powder containment walls 48, 50 define an opening 52 through which the connecting rod 42 vertically moves. The inner containment wall 48 and the outer containment wall 50 are connected by radial spars (not shown) between connecting rods 42, such as spokes in a wheel. In addition, a radial bearing 56 is disposed between the outer powder trap 44 and the outer surface 51 of the outer powder containment wall 50. The radial bearing 56 provides alignment of the outer powder containment wall 50 relative to the outer powder trap 44 and the housing 20 during the build process.

During operation, vertical movement along the z-axis of the platform 30, actuated by actuator 34, translates to vertical movement of the components disposed on the platform 30, and in particular the rotary stage 24, the turntable 14, the connecting rod 42, the base plate 20 and the build platform 18. This vertical movement is simultaneous with rotational movement through an angle “θ” of the rotating portion 26 of the rotary stage 24, which translates to rotational movement of the turntable 14, the base plate 40, the build platform 18 and the build chamber 16. Though both the vertical translation and the rotation are meant to be monotonically increased during operation, it is not necessary that their rates be constant. In this particular embodiment, the configuration provides for rotational movement of the build components on top of the vertical movement of the platform 30 and is referred to herein as “θ on top of z”.

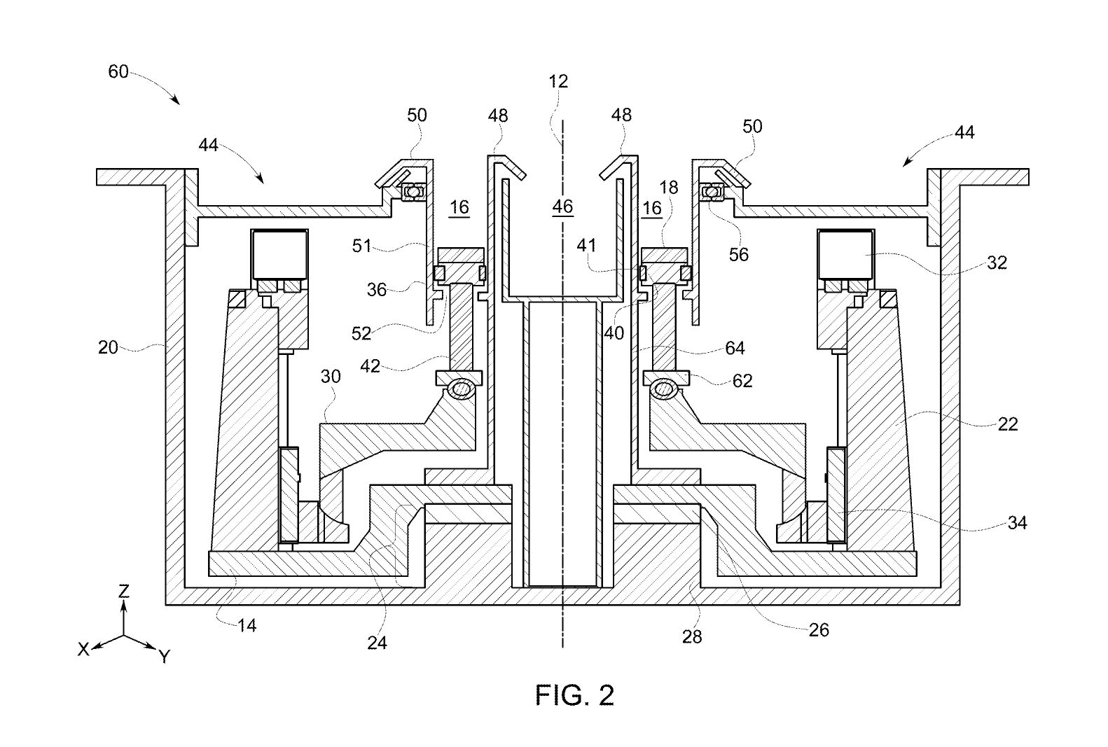

FIG. 2 illustrates another configuration of additive manufacturing apparatus 60, generally similar to apparatus 10 of FIG. 1. It is again noted, that like elements have like numbers throughout the various embodiments. Apparatus 60, like apparatus 10 of FIG. 1, includes a rotatable turntable 14 and a build chamber 16 surrounding a build platform 18, a housing 20, a moveable platform 30 and a support structure 22 disposed in the housing 20. Each of these components will be described in more detail below.

Similar to the embodiment of FIG. 1, the turntable 14 is a rigid structure configured to move vertically (i.e. parallel to the z-axis 12), as well as rotate 360 degrees about the z-axis 12. As illustrated, the turntable 14 is secured to a rotary stage 24, comprised of a rotating portion 26 and a non-rotating portion 28. The rotating portion 26 supports unconstrained rotation of the turntable 14 by an arbitrary number of revolutions to enable building of multiple layers of the part without changing direction of the rotation. More particularly, the turntable 14 is secured to the rotating portion 26 of the rotary stage 24. The rotary stage 24 is secured to the housing 20. A moveable platform 30 is secured to a support structure 22 that is mounted to the turntable 14. The moveable platform 30 is a rigid structure configured to move vertically (i.e. parallel to the z-axis 12). The rotary stage 24 incorporates a direct drive motor, which serves as a rotatory actuator, and is operable to selectively rotating the rotating portion 26 of the rotary stage 24 about the stationary portion 28, which translates to 360 degree rotation of the turntable 14. The rotation of the turntable 14 translates to rotation of the support structure 22 and the moveable platform 30. A motor 32 is operable to selectively move the moveable platform 30 vertically up or down via a linear actuator 34. The linear actuator 34 is secured to the support structure 22 in a manner that provides for the vertical movement of the moveable platform 30. The linear actuator 34 is depicted schematically in FIG. 2. The motor 32 and rotary stage 24 are depicted schematically in FIG. 2, with the understanding that any device that will produce controlled linear and rotary motion respectively may be used for this purpose.

The build chamber 16 is defined by a plurality of sidewalls, and more particularly, an inner powder containment wall 48 and an outer powder containment wall 50. The build platform 18 is a plate-like structure that is vertically slideable in the build chamber 16. The build platform 18 is secured to a base plate 40 and the moveable platform 30 by a connecting rod 42. A rotatable disc 62 is disposed on an uppermost portion of the moveable platform 30 and rotatable therewith.

As illustrated in FIG. 2, disposed within the housing 20 are an outer powder trap 44 and an inner powder trap 46. The inner powder trap 46 extends vertically along the z-axis 12 to rest on a lower portion of the housing 20. The inner powder containment wall 48 and the outer powder containment wall 50 are disposed about the build platform 18. The inner containment wall 48 and the outer containment wall 50 are connected by radial spars (not shown) between connecting rods 42, such as spokes in a wheel. The powder containment walls 48, 50 define an opening 52 through which the connecting rod 42 vertically moves as a result of translated vertical movement of the platform 30. In this particular embodiment, a portion of the inner powder containment wall 50 is extended so as to be mounted to the turntable 14, resulting in rotation of the inner powder containment wall 48 and the outer powder containment wall 50 therewith. More specifically, the inner powder containment wall 48 provides translation of the rotating force of the rotating portion 26 of the rotary stage 24 to the inner powder containment wall 48 and the outer powder containment wall 50. The inner powder containment wall 48 and the outer powder containment wall 50 define a path in the form of an annular ring about the z-axis 12.

A radial bearing 56 is disposed between the outer powder trap 44 and the outer surface 51 of the outer powder containment wall 50. The radial bearing 56 provides alignment of the outer powder containment wall 50 relative to the outer powder trap 44 and the housing 20 during the build process. Metal powder is prevented from falling between the baseplate 40 and the inner containment wall 48 and outer containment wall 50 with a sliding seal 41.

During operation, vertical movement along the z-axis of the platform 30, actuated by actuator 34, translates to vertical movement of the components disposed on the platform 30, and in particular the rotatable disc 62, the connecting rod 42, the base plate 40 and the build platform 18. This vertical movement is simultaneous with rotational movement through an angle “θ” of the rotating portion 26 of the rotary stage 24 about the z-axis 12, which translates to rotational movement of the turntable 14, the support structure 22 and the moveable platform 30, the rotatable disc 62, the connecting rod 42, the inner powder containment wall 48, the outer powder containment wall 50, the base plate 40 and the build platform 18. Though both the vertical translation and the rotation are meant to be monotonically increased during operation, it is not necessary that their rates be constant. In this particular embodiment, the configuration provides for rotational movement below the vertical movement of the platform 30 and is referred to herein as “Z on top of θ”.

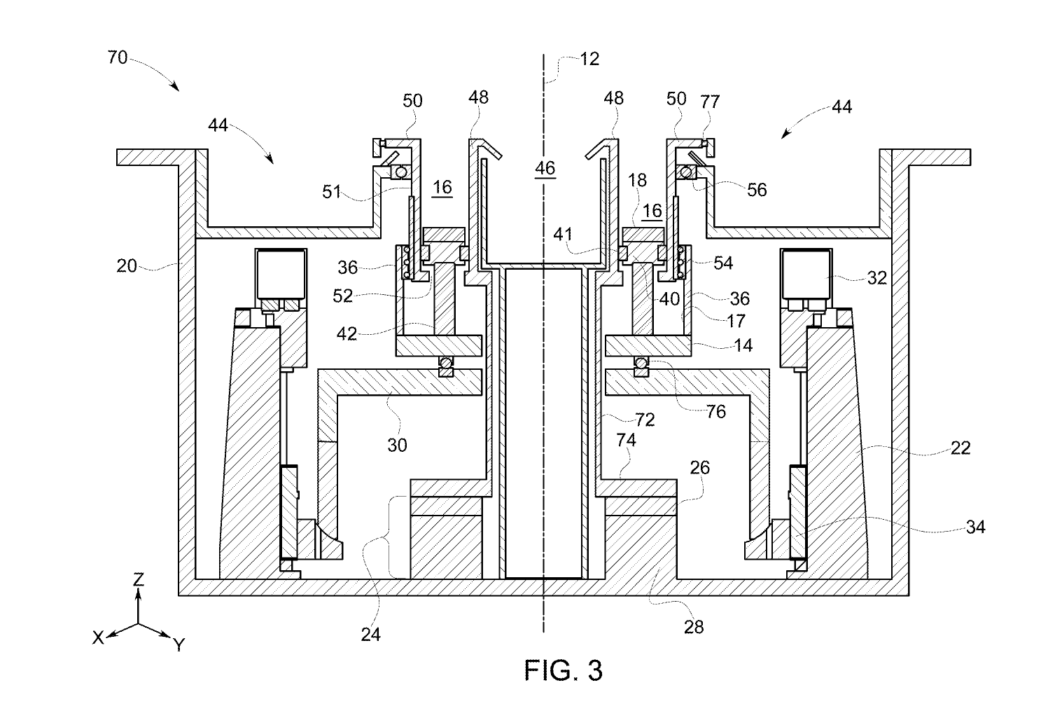

FIG. 3 illustrates yet another configuration of the additive manufacturing apparatus 70, generally similar to apparatus 10 and 60 of FIGS. 1 and 2, respectively. It is again noted, that like elements have like numbers throughout the various embodiments. Apparatus 70, like apparatus 10 and 60 of FIGS. 1 and 2, includes a rotatable turntable 14 and a build chamber 16 surrounding a build platform 18, a housing 20, a moveable platform 30 and a support structure 22 disposed in the housing 20. Each of these components will be described in more detail below.

Similar to the embodiment of FIG. 1, the turntable 14 is a rigid structure configured to move vertically (i.e. parallel to the z-axis 12), as well as rotate continuously about the z-axis 12. In this particular embodiment, the turntable 14 is disposed about a torque cylinder 72. As illustrated, an end portion 74 of the torque cylinder 72 is secured to a rotary stage 24, comprised of a rotating portion 26 and a non-rotating portion 28. The rotating portion 26 supports unconstrained rotation of the turntable 14 by an arbitrary number of revolutions to enable building of multiple layers of the part without changing direction of the rotation. More particularly, the end portion 74 of the torque cylinder 72 is secured to the rotating portion 26 of the rotary stage 24. The rotary stage 24 is secured to the housing 20. A moveable platform 30 is secured to a stationary support structure 22 mounted to the housing 20. The moveable platform 30 is a rigid structure configured to move vertically (i.e. parallel to the z-axis 12). The rotary stage 24 incorporates a direct drive motor, which serves as a rotatory actuator, and is operable to selectively rotating the rotating portion 26 of the rotary stage 24 about the stationary portion 28, which translates to 360 degree rotation of the torque cylinder 72. The rotation of the torque cylinder 72 translates to rotation of the turntable 14 via a linear bearing 54 (described presently). In addition, the motor 32 is operable to selectively move the moveable platform 30 vertically up or down via a linear actuator 34. The linear actuator 34 is secured to the stationary support structure 22 in a manner that provides for the vertical movement of the moveable platform 30. The linear actuator 34 is depicted schematically in FIG. 3. The motor 32 and rotary stage 24 are depicted schematically in FIG. 3, with the understanding that any device that will produce controlled linear and rotary motion may be used for this purpose.

The build chamber 16 is defined by a plurality of sidewalls, and more particularly, an inner powder containment wall 48 and an outer powder containment wall 50. A rotating pillar 36 extends perpendicularly upward from the turntable 14. It should be appreciated that the rotating pillar 36 may extend upwardly from the turntable 14 at angles other than ninety degrees. The rotating pillar 36 provides transmission of the torque from the rotating portion 26 of the rotary stage 24 via the torque cylinder 72, and the inner powder containment wall 48 and the outer powder containment wall 50, to the turntable 14 through the linear bearing 54. The linear bearing 54 is disposed between an outer surface of the build chamber 16, and more particularly an outer surface 51 of the outer powder containment wall 50, and an inner surface 17 of the rotating pillar 36. The inner containment wall 48 and the outer containment wall 50 are connected by radial spars (not shown) between connecting rods 42, such as spokes in a wheel. The inner powder containment wall 48 and the outer powder containment wall 50 define a path in the form of an annular ring about the z-axis 12.

The build platform 18 is secured to a base plate 40 and the turntable 14 by a connecting rod 42. A thrust bearing 76 is disposed on an uppermost portion of the moveable platform 30 to provide for the translation of the vertical movement from the moveable platform 30 to the rotating turntable 14.

As illustrated in FIG. 3, disposed within the housing 20 are an outer powder trap 44 and an inner powder trap 46. The inner powder trap 46 extends vertically along the z-axis 12 to rest on a lower portion of the housing 20. The inner powder containment wall 48 and the outer powder containment wall 50 are disposed about the build platform 18. The powder containment walls 48, 50 define an opening 52 through which a connecting rod 42 vertically moves as a result of translated vertical movement of the platform 30. The linear bearing 54 additionally provides z-axis alignment of the build chamber 16 during the build process and translation of the rotating force of the rotating portion 26 of the rotary stage and torque cylinder 72, to the turntable 14. In addition, a radial bearing 56 is disposed between the outer powder trap 44 and the outer surface 51 of the outer powder containment wall 50. The radial bearing 56 provides alignment of the outer powder containment wall 50 relative to the outer powder trap 44 and the housing 20 during the build process. In this particular embodiment, a seal 77 is provided between the outer powder containment wall 50 and the outer powder trap 44. The seal 77 may be formed of any material capable of sealing between the outer powder containment wall 50 and the outer powder trap 44, such as, but not limited to, felt, metal or rubber. The seal 77 provides for free movement of the turntable 14 and translates the vertical motion of the connecting rod 42, the base plate 40 and the build platform 18. The seal 77 further prevents metal powder from falling/seeping between the rotating outer build chamber wall 50 and the stationary powder trap 44 and radial bearing 56. This seal may be omitted if other means of powder containment are provided, such as overhanging or labyrinthine structures. Metal powder is prevented from falling between the baseplate 40 and the inner containment wall 48 and outer containment wall 50 with a sliding seal 41.

During operation, vertical movement along the z-axis 12 of the platform 30, actuated by actuator 34, translates to vertical movement of the components disposed on the platform 30, and in particular the turntable 14, the connecting rod 42, the base plate 40 and the build platform 18. This vertical movement is simultaneous with rotational movement through an angle “θ” of the rotating portion 26 of the rotary stage 24, which translates to rotational movement of the torque cylinder 72, the build chamber 16, the turntable 14, the connecting rod 42, the base plate 40 and the build platform 18. Though both the vertical translation and the rotation are meant to be monotonically increased during operation, it is not necessary that their rates be constant. In this particular embodiment, the configuration provides for rotational movement through the torque cylinder 72 and is referred to herein as “θ through the torque cylinder”.

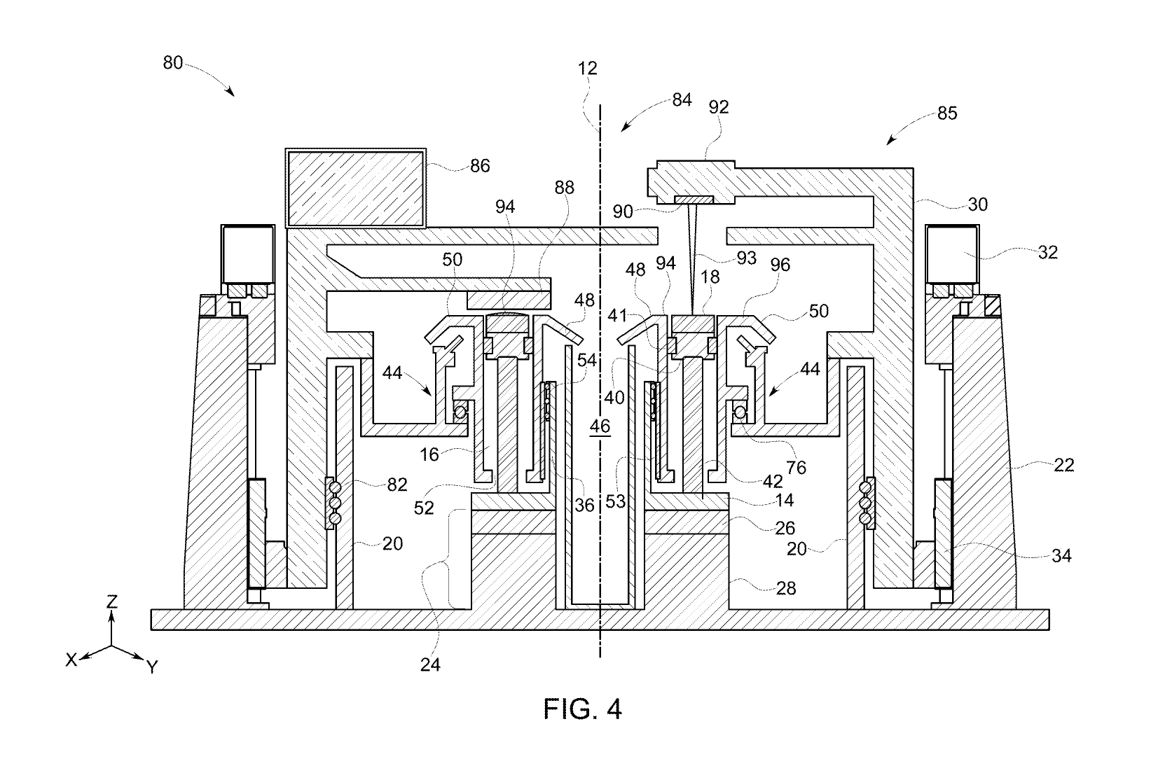

FIG. 4 illustrates yet another configuration of additive manufacturing apparatus 80, generally similar to apparatus 10, 60 and 70 of FIGS. 1-3, respectively. It is again noted, that like elements have like numbers throughout the various embodiments. Apparatus 80, like apparatus 10, 60 and 70 of FIGS. 1-3, includes a rotatable turntable 14 and a build chamber 16 surrounding a build platform 18, a housing 20, a moveable platform 30 and a support structure 22. Each of these components will be described in more detail below.

Similar to the embodiment of FIG. 1, the turntable 14 is a rigid structure configured to move vertically (i.e. parallel to the z-axis 12), as well as rotate 360 degrees about the z-axis 12. As illustrated, the turntable 14 is secured to a rotary stage 24, comprised of a rotating portion 26 and a non-rotating portion 28. The rotating portion 26 supports unconstrained rotation of the turntable 14 by an arbitrary number of revolutions to enable building of multiple layers of the part without changing direction of the rotation. The turntable 14 is secured to the rotating portion 26 of the rotary stage 24. The rotary stage 24 is secured to the housing 20. A moveable platform 30 is secured to a stationary support structure 22 mounted to the housing 20. The moveable platform 30 is a rigid structure configured to move vertically (i.e. parallel to the z-axis 12). The rotary stage 24 incorporates a direct drive motor, which serves as a rotatory actuator, and is operable to selectively rotating the rotating portion 26 of the rotary stage 24, which translates to continuous rotation of the turntable 14. The rotation of the turntable 14 translates via a translating wall 36 and linear bearing 54 to rotation of an inner powder containment wall 48 and an outer powder containment wall 50 that defines the build chamber 16. A motor 32 is operable to selectively move the moveable platform 30 vertically up or down via a linear actuator 34. The linear actuator 34 is secured to the stationary support structure 22 in a manner that provides for the vertical movement of the moveable platform 30. In this particular embodiment, the moveable platform 30 is configured as a portion of an optical module (described presently), that includes at least one build unit. The linear actuator 34 is depicted schematically in FIG. 3. The motor 32 and the rotary stage 24 are depicted schematically in FIG. 3, with the understanding that any device that will produce controlled rotary motion may be used for this purpose.

The build chamber 16 is defined by a plurality of sidewalls, and more particularly, the inner powder containment wall 48 and the outer powder containment wall 50. The rotating pillar 36 extends perpendicularly upward from the turntable 14. It should be appreciated that the rotating pillar 36 may extend upwardly from the turntable 14 at angles other than ninety degrees. The rotating pillar 36 provides transmission of the torque from the rotating portion 26 of the rotary stage 24 to the inner powder containment wall 48 and the outer powder containment wall 50 via the linear bearing 54. The linear bearing 54 is disposed between an outer surface of the build chamber 16, and more particularly an outer surface 53 of the inner powder containment wall 48, and an inner surface 17 of the rotating pillar 36. The inner containment wall 48 and the outer containment wall 50 are connected by radial spars (not shown) between connecting rods 42, such as spokes in a wheel. Metal powder is prevented from falling between the baseplate 40 and the inner containment wall 48 and outer containment wall 50 with a sliding seal 41. The inner powder containment wall 48 and the outer powder containment wall 50 define a path in the form of an annular ring about the z-axis 12.

The build platform 18 is a plate-like structure that is vertically slideable in the build chamber 16. The build platform 18 is secured to a base plate 40 and the turntable 14 by a connecting rod 42. A thrust bearing 76 is disposed on the outer powder trap 44 to provide for the translation of the vertical movement from the moveable platform 30 to the build chamber 16.

As illustrated in FIG. 4, disposed within the housing 20 are the outer powder trap 44 and the inner powder trap 46. The inner powder trap 46 extends vertically along the z-axis 12 to rest on a lower portion of the housing 20. The inner powder containment wall 48 and the outer powder containment wall 50 are disposed about the build platform 18. The powder containment walls 48, 50 define an opening 52 through which the connecting rod 42 is positioned to allow for vertically movement of the powder containment walls 48, 50 as a result of translated vertical movement of the platform 30. The linear bearing 54 additionally provides z-axis alignment of the build chamber 16 during the build process. As previously described, a thrust bearing 76 is disposed between the outer powder trap 44 and the outer surface 51 of the outer powder containment wall 50. In addition to translating the vertical movement of the platform 30 to the powder containment walls 48, 50 and thus the build chamber 16, the thrust bearing 76 provides alignment of the outer powder containment wall 50 relative to the outer powder trap 44 and the housing 20 during the build process.

During operation, vertical movement along the z-axis 12 of the platform 30, actuated by actuator 34, aided by a linear bearing 82, translates to vertical movement of the inner and outer containment walls 48, 50, respectively, defining the build chamber 16. This vertical movement is simultaneous with rotational movement through an angle “θ” of the rotating portion 26 of the rotary stage 24, which translates to rotational movement of the turntable 14, the inner and outer powder containment walls 48, 50, respectively, defining the build chamber 16, the connecting rod 42, the base plate 40 and the build platform 18.

In each of the disclosed embodiments, one or more build units are mounted relative to the described components of FIGS. 1-4, and configured for movement along a pre-defined path defined by the components. The one or more build units are configured for continuous operation and collectively include a powder dispenser positioned above the build chamber, an applicator configured to level the powder dispensed into the build chamber and a directed energy source configured to fuse the leveled powder. It should be understood that throughout the various embodiments, the term “continuous operation” is not intended to imply a constant velocity, but rather operation with varying velocities about the z-axis and theta throughout a build. As an example, further illustrated in this particular embodiment is a fusing assembly 84 as part of an optical module 85. The fusing assembly 84 comprises a powder container 86, a powder applicator 88, a directed energy source 90 and a radial actuator 92. The fusing assembly 84 is one example of a “build unit” which refers generally to any assembly positioned over the build chamber 16 and configured to perform one or more steps of an additive build process. Other types of build units are anticipated. In some embodiments, multiple fusing assemblies 84 may be configured. In other embodiments, multiple powder containers 86 and powder applicators 88 may be configured with a single directed energy source 90.

The powder applicator 88 is a rigid, laterally-elongated structure that, when used, scrapes along at a fixed distance above the build platform 18 to provide a layer increment of a powder 94 thereon the build platform 18, between the inner powder containment wall 48 and the outer powder containment wall 50.

The powder container 86 may be in the form of a hopper having a spout for supplying powder 94 to the powder applicator 88. A metering valve (not shown) may be used to control the deposition rate of powder 94 based on multiple factors such as the size of the build platform 18, a desired layer increment thickness, and the relative speed between the build platform 18 and the fusing unit 84.

The directed energy source 90 may comprise any known device operable to generate a beam 93 of suitable power and other operating characteristics to melt and fuse the powder 94 during the build process. For example, the directed energy source 90 may be a laser, or an array of lasers. Other directed-energy sources such as electron beam guns are suitable alternatives to a laser. A radial actuator 92 provides radial movement of the directed energy source 90 so as to position the directed energy source 90 to a desired position in an X-Y plane coincident with the build platform 18.

In an embodiment, a beam steering apparatus (not shown), such as one or more mirrors, prisms, and/or lenses, may be incorporated and provided with suitable actuators, and arranged so that the beam 93 from the directed energy source 90 can be focused to a desired spot size and steered to a desired position in an X-Y plane coincident with the build platform 18.

A controller (not shown) controls the directed energy source 90, the powder container 86, and the powder applicator 88 of the fusing assembly 84. The controller may use data from imaging components, or the like, to control the powder flow rate and/or to stop the build process upon detection of a defect.

For purposes of clarity, the primary build process will be described using additive manufacturing apparatus 80, but is applicable to each of the disclosed embodiments. The build process for a part using the additive manufacturing apparatus 80 described above is as follows. The fusing assembly 84 is prepared by filling the powder container 86 with powder 94. In this particular embodiment, the fusing assembly 84 is integrally formed with the moveable platform 30. In an alternative embodiment, such as for use with the apparatus 10, 60 or 70 of FIGS. 1-3, the fusing assembly 84 is positioned such that seal is formed between the fusing assembly 84 and the housing 20. It should be appreciated that positioning the fusing assembly 84 may be accomplished by using the actuator 92 or actuator 34 to lower or raise the fusing assembly 84.

The fusing assembly 84 is positioned, such that the build platform 18 is an initial starting position. The initial position of the build platform 18 is located below upper surfaces 94 and 96 of the inner powder containment wall 48 and the outer powder containment wall 50, and which define an opening to the build chamber 16 by a selected layer increment. The layer increment affects the speed of the additive manufacturing process and the resolution of the part. As an example, the layer increment may be about 10 to 50 micrometers (0.0004 to 0.002 in.). The turntable 14 is rotated by the motor 32 at a pre-determined rotational speed selected to permit the fusing assembly 84 to melt or fuse the powder 94 being dropped onto the build platform 18 to form a part. It should be appreciated that more than one fusing assembly 84 may be used to speed up and provide a more efficient build process.

With the turntable 14 rotating, the powder 94 is then deposited over the build platform 18. The build platform 18 rotates underneath the powder applicator 88, which acts to spread the raised powder 94 across the build platform 18. Any excess powder 94 is pushed along the build platform 18 as the turntable 18 rotates to provide a continuous powder deposition and spreading. Though both the vertical translation and the rotation are meant to be monotonically increased during operation, it is not necessary that their rates be constant.

As the powder is deposited and spread onto the rotating build platform 18, the directed energy source 90 is used to melt a two-dimensional cross-section or layer of the part being built. The directed energy source 90 emits the beam 93 that is focused over the exposed powder surface in an appropriate pattern. The exposed layer of the powder 94 is heated by the beam 93 to a temperature allowing it to melt, flow, and consolidate. This step may be referred to as fusing the powder 94.

Once the first layer increment of powder 94 is fused, the build platform 18 is moved vertically downward by the layer increment, as described herein and another layer of powder 94 is applied in a similar thickness. The directed energy source 90 continues to emit a beam 93 over the exposed powder surface in an appropriate pattern. The exposed layer of the powder 94 is heated by the beam 93 to a temperature allowing it to melt, flow, and consolidate both within the top layer and with the lower, previously-solidified layer. It should be appreciated that the process of depositing the powder 94 and using the directed energy source 90 to fuse the powder can be continuous as the part is being formed, with the process only being stopped when the part is completed or when a defect or malfunction is detected. It should also be appreciated that when multiple fusing units 84 are employed that each unit may be used to form a single increment layer or to form multiple increment layers.

This cycle of moving the build platform 18, applying powder 94, and then directed energy melting the powder 94 is repeated until the entire part is complete. It is also noted that the vertical movement of build platform 18 or the inner powder containment wall 48 and outer powder containment wall 50 is continuous during the build process, so that the part builds continuously in a spiral configuration with the powder deposition and fusing occurring simultaneously in time at different azimuthal positions along the circumference of the build plate.

After the part is complete, the inner powder containment wall 48 and the outer powder containment wall 50 may then be lowered and the fusing assembly 84 raised to disengage the fusing assembly 84 and expose the part above the inner powder containment wall 48 and the outer powder containment wall 50. In the case of additive manufacturing apparatus 10, 60 and 70, the build platform 18 is raised and the fusing assembly 84 is raised to disengage the fusing assembly 84 and expose or expose the part above the inner powder containment wall 48 and the outer powder containment wall 50.

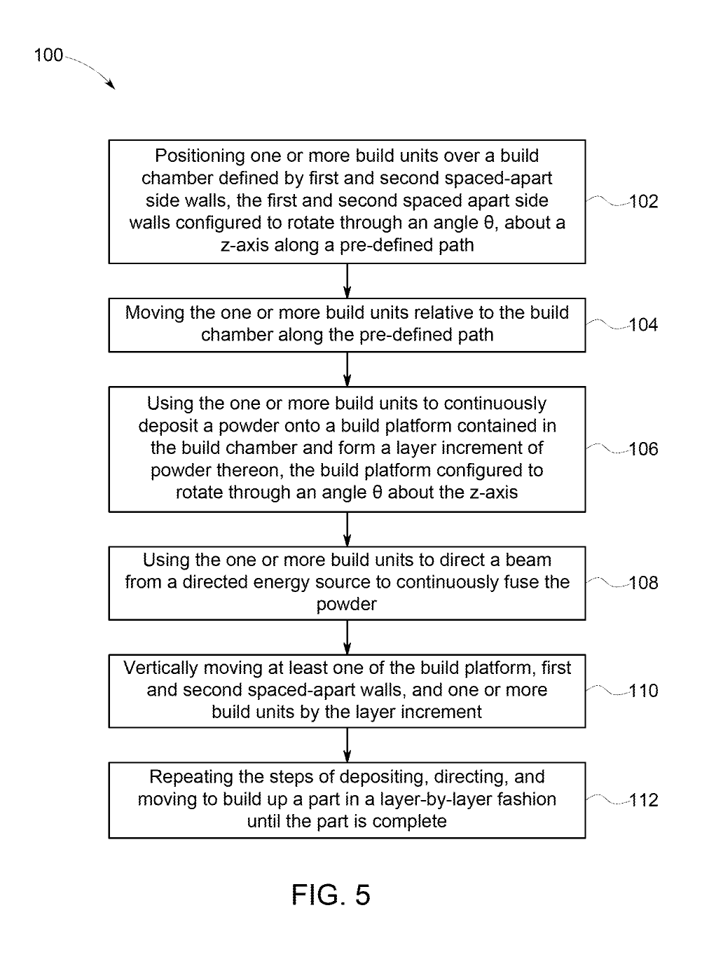

FIG. 5 is a flowchart of an additive manufacturing method 100, in accordance with an embodiment disclosed herein. As shown in FIG. 5, the additive manufacturing method 100 comprises positioning one or more build units over a build chamber defined by first and second spaced-apart side walls, in a step 102. As previously described, the first and second spaced apart side walls are configured to rotate through an angle θ, about a z-axis along a pre-defined path. Next, the one or more build units are positioned relative to the build chamber along the pre-defined path, in a step 104. A powder is next continuously deposited onto a build platform contained in the build chamber using the one or more build units, in a step 106. The depositing of the powder forms a layer increment of powder thereon the build platform. As previously described, the build platform is configured to rotate through an angle θ about the z-axis and vertically moveable along the z-axis. In a step 108, a beam from a directed energy source is directed by the build unit to continuously fuse the powder. Next, at least one of the build platform, the first and second spaced-apart walls, and the one or more build units are vertically moved by the layer increment, in a step 110. The steps of depositing, directing, and moving are repeated, in a step 112, to build up a part in a layer-by-layer fashion until the part is complete.

The foregoing has described apparatus and methods for additive manufacture of large parts. The disclosed additive manufacturing system provides an integrated machine for building nominally axisymmetric metal parts from metal powder using a directed energy source, such as a laser or laser array. In addition, the disclosed additive manufacturing system provides an integrated machine for building any type of part, including non-axisymmetric parts that can be built on a rotational platform from metal powder using a directed energy source, such as a laser or laser array. The system includes continuous rotation of the build part, and continuous operation of one or more recoaters and laser stations. The system may further include local gas cover for inert gas and spatter collection. The continuous rotation of the additive manufacturing system provides for continuous powder recoating, increasing productivity over systems that require serial operation of the lasers and recoater. The apparatus and method as disclosed minimizes excess powder while providing for continuous powder recoating and fusing. Continuous operation of the apparatus provides increased productivity over systems that require serial operation of the laser and recoater. As previously stated, the term “continuous operation” used throughout this disclosure is not intended to imply a constant velocity, but rather operation with varying velocities about the z-axis and theta throughout a build. The apparatus may be tailored to specific geometries, avoiding a compromise that is required when one machine must make a range of part geometries

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

While the invention has been described in terms of one or more particular embodiments, it is apparent that other forms could be adopted by one skilled in the art. It is understood that in the method shown and described herein, other processes may be performed while not being shown, and the order of processes can be rearranged according to various embodiments. Additionally, intermediate processes may be performed between one or more described processes. The flow of processes shown and described herein is not to be construed as limiting of the various embodiments.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An additive manufacturing apparatus, comprising:
first and second spaced apart side walls defining a build chamber therebetween, the first and second spaced apart side walls configured to rotate through an angle θ, about a z-axis along a pre-defined path;
a build platform defined within the first and second spaced apart side walls and configured to rotate through an angle θ about the z-axis and vertically moveable along the z-axis; and
one or more build units mounted for movement along the pre-defined path.

2. The apparatus according to claim 1, wherein the pre-defined path is a ring.

3. The apparatus according to claim 1, wherein the first spaced apart side wall is an inner powder containment wall and the second spaced apart sidewall is an outer powder containment wall.

4. The apparatus according to claim 1, wherein the one or more build units collectively include:
a powder dispenser positioned above the build chamber;
an applicator configured to level the powder dispensed into the build chamber; and
a directed energy source configured to fuse the leveled powder,
wherein the powder dispenser, the applicator and the directed energy source are configured for continuous operation.

5. The apparatus according to claim 1, further comprising a turntable coupled to one of the first or second spaced apart side walls.

6. The apparatus according to claim 5, wherein the turntable is configured to rotate through the angle θ about the z-axis and vertically moveable along the z-axis.

7. The apparatus according to claim 6, further comprising a moveable platform coupled to a support structure and vertically moveable along the z-axis and a rotary stage comprising a non-rotating portion and a rotating portion.

8. The apparatus according to claim 7, wherein the turntable is disposed on an uppermost surface of the rotating portion of the rotary stage and rotatable therewith through the angle θ about the z-axis, the rotation of the rotary stage translating to a connecting rod supporting the build platform and the inner and outer powder containment walls, and wherein the non-rotating portion of the rotary stage is disposed on an uppermost surface of the moveable platform and vertically moveable therewith along the z-axis, the vertical movement of the moveable platform translating to the rotary stage, the turntable, the connecting rod and the build platform.

9. The apparatus according to claim 7, wherein the turntable is disposed on an uppermost surface of the rotating portion of the rotary stage and rotatable therewith through the angle θ about the z-axis, and wherein the moveable platform is disposed on an uppermost surface of the turntable and rotatable therewith through the angle θ about the z-axis and vertically moveable along the z-axis, the rotation of the rotary stage translating to the inner and outer powder containment walls, and the vertical movement of the moveable platform translating to the connecting rod and the build platform.

10. The apparatus according to claim 7, further comprising a torque cylinder coupled to the rotating portion of the rotary stage and rotatable therewith through the angle θ about the z-axis, the rotation of the rotary stage and the torque cylinder translating to rotation of the inner and outer powder containment walls, the turntable and a connecting rod supporting the build platform, and wherein the moveable platform is vertically moveable along the z-axis, the vertical movement of the moveable platform translating to vertical movement of the turntable, the connecting rod and the build platform.

11. The apparatus according to claim 7, wherein the turntable is disposed on an uppermost surface of the rotating portion of the rotary stage and rotatable therewith through the angle θ about the z-axis, and wherein the moveable platform is vertically moveable along the z-axis, the rotation of the rotary stage translating to the inner and outer powder containment walls, the connecting rod and the build platform and the vertical movement of the moveable platform translating to vertical movement of the inner and outer powder containment walls.

12. The apparatus according to claim 11, wherein the one or more build units comprise a fusing assembly, wherein the moveable platform is formed as a part thereof, and wherein the fusing assembly is vertically moveable along the z-axis.

13. An additive manufacturing apparatus, comprising:
an outer powder containment wall defining a build chamber therein, the outer powder containment wall configured to rotate through an angle θ, about a z-axis along a pre-defined path;
a build platform defined within the build chamber and configured to rotate through an angle θ about the z-axis and vertically moveable along the z-axis;
one or more build units mounted for movement along the pre-defined path, the one or more build units collectively including:
a powder dispenser positioned above the build chamber;
an applicator configured to level the powder dispensed into the build chamber; and
a directed energy source configured to fuse the leveled powder,
wherein the powder dispenser, the applicator and the directed energy source are configured for continuous operation.

14. The apparatus according to claim 13, further comprising an inner powder containment wall, together with the outer powder containment wall defining the build chamber therebetween, the inner powder containment wall configured to rotate through an angle θ, about the z-axis along the pre-defined path.

15. The apparatus according to claim 13, further comprising a turntable coupled to one of the inner powder containment wall or the outer powder containment wall, the turntable configured to rotate through the angle θ about the z-axis and vertically moveable along the z-axis.

16. The apparatus according to claim 15, further comprising a moveable platform coupled to a support structure and vertically moveable along the z-axis and a rotary stage comprising a non-rotating portion and a rotating portion.

17. The apparatus according to claim 16, wherein the turntable is disposed on an uppermost surface of the rotating portion of a rotary stage and rotatable therewith through the angle θ about the z-axis, the rotation of the rotary stage translating to a connecting rod supporting the build platform and the outer powder containment wall, and wherein the non-rotating portion of the rotary stage is disposed on an uppermost surface of the moveable platform and vertically moveable therewith along the z-axis, the vertical movement of the moveable platform translating to the rotary stage, the turntable, the connecting rod and the build platform.

18. The apparatus according to claim 16, wherein the turntable is disposed on an uppermost surface of the rotating portion of a rotary stage and rotatable therewith through the angle θ about the z-axis, and wherein the moveable platform is disposed on an uppermost surface of the turntable and rotatable therewith through the angle θ about the z-axis and vertically moveable along the z-axis, the rotation of the rotary stage translating to the outer powder containment wall, and the vertical movement of the moveable platform translating to the connecting rod and the build platform.

19. The apparatus according to claim 16, further comprising a torque cylinder coupled to the rotating portion of a rotary stage and rotatable therewith through the angle θ about the z-axis, the rotation of the rotary stage and the torque cylinder translating to rotation of the outer powder containment wall, the turntable and a connecting rod supporting the build platform, and wherein the moveable platform is vertically moveable along the z-axis, the vertical movement of the moveable platform translating to vertical movement of the turntable, the connecting rod and the build platform.

20. The apparatus according to claim 16, wherein the turntable is disposed on an uppermost surface of the rotating portion of the rotary stage and rotatable therewith through the angle θ about the z-axis, and wherein the moveable platform is vertically moveable along the z-axis, the rotation of the rotary stage translating to the outer powder containment wall, the connecting rod and the build platform and the vertical movement of the moveable platform translating to vertical movement of the inner and outer powder containment walls.

21. The apparatus according to claim 20, wherein the one or more build units comprise a fusing assembly, wherein the moveable platform is formed as a part thereof, and wherein the fusing assembly is vertically moveable along the z-axis.

22. An additive manufacturing method, comprising:
positioning one or more build units over a build chamber defined by first and second spaced-apart side walls, the first and second spaced apart side walls configured to rotate through an angle θ, about a z-axis along a pre-defined path;
moving the one or more build units relative to the build chamber along the pre-defined path;
using the one or more build units to continuously deposit powder onto a build platform contained in the build chamber and form a layer increment of powder thereon, the build platform configured to rotate through an angle θ about the z-axis and vertically moveable along the z-axis;
using the one or more build units to direct a beam from a directed energy source to continuously fuse the powder;
vertically moving at least one of the build platform, first and second spaced-apart walls, and one or more build units by the layer increment in a continuous manner; and
continuously repeating in a cycle the steps of depositing, directing, and moving to build up a part in a layer-by-layer fashion until the part is complete.

23. The method according to claim 22, wherein the one or more build units include:
a powder unit comprising a powder dispenser and an applicator; and
a fusing unit comprising a directed energy source.

24. The method according to claim 221, wherein one of the build units is a fusing unit comprising a powder dispenser, an applicator, and a directed energy source.

25. The method according to claim 22, wherein the pre-defined path is a ring.
